(19) United States
(12) Patent Application Publication
(10) Pub. No.: US 2021/0119334 A1
(43) Pub. Date: Apr. 22, 2021

(54) ANTENNA FOR OPTICAL AND RF SIGNAL TRANSMISSION AND RECEPTION

(71) Applicant: The Charles Stark Draper Laboratory, Inc., Cambridge, MA (US)

(72) Inventors: Juha-Pekka J. Laine, Boston, MA (US); Amy E. Duwel, Cambridge, MA (US); Jacob P. Treadway, Lexington, MA (US); Robert Larsen, Somerville, MA (US); Steven J. Spector, Lexington, MA (US); Benjamin F. Lane, Sherborn, MA (US); Stephen P. Smith, Acton, MA (US)

(21) Appl. No.: 16/658,908

(22) Filed: Oct. 21, 2019

(51) Int. Cl. H01Q 5/22; H01Q 1/36; H01Q 1/22; H01Q 23/00

(52) U.S. Cl. CPC H01Q 5/22; H01Q 23/00; H01Q 1/2283; H01Q 1/36

(57) ABSTRACT

An optical and radio frequency (RF) antenna includes a substrate and a spiral pattern formed on and/or in the substrate from a metallic material. The spiral pattern has a central region and peripheral region surrounding the central region. The central region is configured to transmit and receive an optical signal at optical and/or infrared wavelengths and the peripheral region is configured to transmit and receive an RF signal at RF wavelengths. The central region and the peripheral region are configured such that an optical gain pattern of the central region and an RF gain pattern of the peripheral region are co-boresighted.

### TECHNICAL FIELD

The present invention generally relates to communication antennas and, more particularly, the invention relates to communication antennas for optical and RF signal transmission and reception.

### BACKGROUND ART

Some existing optical communication systems switch from transmitting optical signals to transmitting radio frequency (RF) signals in changing weather conditions, for example, on cloudy days when optical signals may be obstructed. Previous methods of combining an optical lens with an RF antenna have led to Cassegrain-type systems with large metallic mirror structures. However, these systems have large footprints that may not be suitable for many applications.

### SUMMARY OF EMBODIMENTS

In accordance with one embodiment of the invention, an optical and radio frequency (RF) antenna includes a substrate and a spiral pattern formed on and/or in the substrate from a metallic material. The spiral pattern has a central region and a peripheral region surrounding the central region. The central region is configured to transmit and receive an optical signal at optical and/or infrared wavelengths and the peripheral region is configured to transmit and receive an RF signal at RF wavelengths. The central region and the peripheral region are configured such that an optical gain pattern of the central region and an RF gain pattern of the peripheral region are co-boresighted.

In related embodiments, the central region may be configured to focus the optical signal at a distance away from the substrate. The spiral pattern may be formed from two or more spiral patterns interleaved with one another. The spiral pattern may be formed from two or more spiral patterns layered on top of one another. The spiral pattern may be formed with a structured spiral having nanometer dimensions in the central region and micrometer dimensions in the peripheral region. The substrate may be a silicon wafer.

In accordance with another embodiment of the invention, an optical and RF antenna system includes the optical and RF antenna, as described above, first driving circuitry, in communication with the optical and RF antenna, configured to drive the central region so as to transmit the optical signal and/or configured to drive the peripheral region so as to transmit the RF signal, and first processing circuitry, in communication with the optical and RF antenna, configured to process the optical signal received in the central region and/or configured to process the RF signal received in the peripheral region.

In related embodiments, the first driving circuitry may be formed on and/or in the substrate or may be coupled to the substrate. The first processing circuitry may be formed on and/or in the substrate or may be coupled to the substrate. The optical and RF antenna system may further include second processing circuitry, in communication with the optical and RF antenna, configured to process the optical signal received in the central region and/or configured to process the RF signal received in the peripheral region. The first processing circuitry may be configured to process the optical signal received in the central region and the second processing circuitry may be configured to process the RF signal received in the peripheral region. The optical and RF antenna system may further include second driving circuitry, in communication with the optical and RF antenna, configured to drive the central region so as to transmit the optical signal and/or configured to drive the peripheral region so as to transmit the RF signal. The first driving circuitry may be configured to drive the central region and the second driving circuitry may be configured to drive the peripheral region.

In accordance with another embodiment of the invention, an optical and RF communication system includes a first optical and RF antenna system, as described above, and a second optical and RF antenna system, as described above, in communication with the first optical and RF antenna system.

In related embodiments, the optical and RF communication system may further include one or more optical antenna systems in communication with the first optical and RF antenna system and/or the second optical and RF antenna system. The optical and RF communication system may further include one or more RF antenna systems in communication with the first optical and RF antenna system and/or the second optical and RF antenna system. The optical and RF communication system may further include one or more optical antenna systems in communication with the first optical and RF antenna system and/or the second optical and RF antenna system, and one or more RF antenna systems in communication with the first optical and RF antenna system and/or the second optical and RF antenna system.

In accordance with another embodiment of the invention, an optical and radio frequency (RF) antenna includes a substrate, and one or more optical-RF grating structures formed on and/or in the substrate from a metallic material. The one or more optical-RF grating structures is configured to receive and transmit an optical signal at optical and/or infrared wavelengths and is configured to receive and transmit an RF signal at RF wavelengths. The one or more optical-RF grating structures is configured to focus the optical signal coherently, to transmit the optical signal coherently, to capture the optical signal into the substrate, to collect the RF signal into the substrate, and to transmit the RF signal.

### BRIEF DESCRIPTION OF THE DRAWINGS

The foregoing features of the invention will be more readily understood by reference to the following detailed description, taken with reference to the accompanying drawings, in which:

FIG. 1A is a front view of an antenna having a spiral grating structure configured to transmit and receive an optical signal and to transmit and receive an RF signal according to embodiments of the present invention;

FIG. 1B is a side view of the antenna shown in FIG. 1A showing the receiving and focusing of optical signals with the antenna according to embodiments of the present invention;

FIG. 2A is a front view of an antenna having a non-spiral grating structure configured to transmit and receive an optical signal and to transmit and receive an RF signal according to embodiments of the present invention;

FIG. 2B is a side view of the antenna shown in FIG. 2A showing the receiving and focusing of optical signals with the antenna according to embodiments of the present invention;

FIG. 2C is a side view of an alternative configuration for the antenna shown in FIG. 2A showing the receiving and capturing/coupling of optical signals with the antenna according to embodiments of the present invention;

FIG. 3 shows an optical/RF antenna system having an antenna configured to transmit and receive optical and RF signals according to embodiments of the present invention;

FIG. 4 shows a communication system including a first optical/RF antenna system in communication with a second optical/RF antenna system according to embodiments of the present invention; and

FIG. 5 shows a communication network including a first optical/RF antenna system in communication with a second optical/RF antenna system, an optional RF antenna system, and an optional optical antenna system according to embodiments of the present invention.

### DESCRIPTION OF ILLUSTRATIVE EMBODIMENTS

Various embodiments of the present invention provide an on-chip, optical focusing lens and RF antenna combined in one structure. The antenna structure may be patterned on and/or in a substrate, e.g., a silicon wafer, from a metallic material and configured to transmit and receive both optical and RF signals such that the optical and RF gain patterns are co-boresighted. Such a combined antenna can be used in directional communication systems, such as in all-weather, high-bandwidth applications, which allows both the optical and RF modalities to be operated simultaneously in order to establish communication with a higher-bandwidth optical transmitter-receiver system when the desired path becomes available. The antenna may also be used in pointing and tracking applications and information security applications.

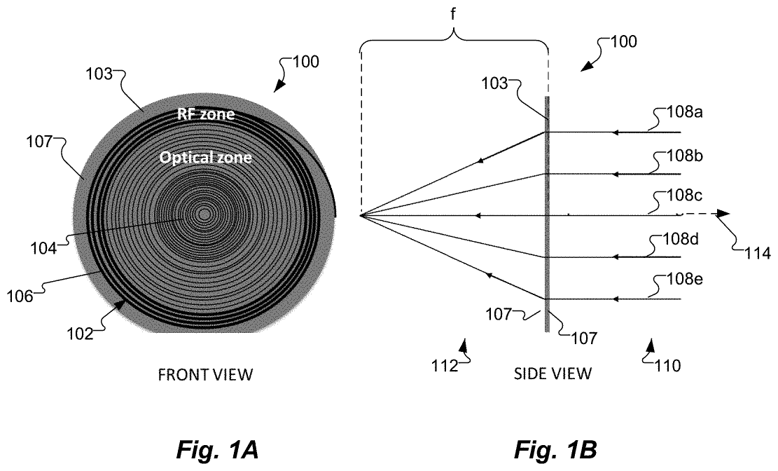

FIG. 1A is a front view of an antenna configured to transmit and receive optical signals and to transmit and receive RF signals according to embodiments of the present invention. The antenna 100 includes a spiral pattern 102 formed on and/or in a substrate 103, e.g., a silicon or silicon-on-insulator (SIO) wafer, from a metallic material. Preferably, the antenna 100 is a monolithic structure. The spiral pattern 102 is configured to focus light coherently while simultaneously operating as an RF antenna. The antenna 100 has a central region 104, e.g., an “optical zone”, for focusing optical signals coherently and a peripheral region 106, e.g., an “RF zone”, surrounding the central region 104, for transmitting and/or receiving RF signals. Advantageously, in this embodiment, the same material and structure that forms the RF antenna can also focus the light.

The spiral pattern 102 may include one or more features, e.g., metal lines or traces, deposited or formed on a surface 107 of the substrate 103 and/or formed in the substrate 103. The spiral pattern 102 may be formed with a structured spiral pattern having nanometer dimensions in the central region 104 and micrometer dimensions in the peripheral region 106. Dimensions of features, and spacings between adjacent features, may be based on wavelengths of the light, and optionally the wavelengths of the RF signals, to be handled by the respective zones 104 and 106 of the antenna 100. For example, the spiral pattern 102 may have features in the central region 104 with a thickness that ranges from about 1 nm to about 1000 nm and with a spacing between adjacent features that ranges from about 10 nm to about 1000 nm apart, depending on wavelength of the light to be focused by the central region 104. The spiral pattern 102 may have features in the peripheral region 106 with a thickness that ranges from about 1 μm to about 1000 μm and with a spacing between adjacent features that ranges from about 1 μm to about 1000 μm apart, optionally depending on the wavelength of the RF signals to be received and/or transmitted by the peripheral region 106. The thickness of the features and/or the spacing between adjacent features may be the same within each region. For example, the spiral pattern 102 may have one thickness and/or spacing for the central region 104 and a different thickness and/or spacing for the peripheral region 106. Alternatively, the thickness of the features and/or the spacing between adjacent features may vary within a region. For example, the spiral pattern 102 in the peripheral region 106 may have features that are thinner near the central region 104 and features that are thicker toward an outer edge of the peripheral region 106 further away from the central region 104. The spiral pattern 102 may be formed from one continuous feature. The spiral pattern 102 may also include two or more spiral patterns. For example, the spiral pattern may include two or more spiral patterns interleaved with one another and/or two or more spiral patterns layered on top of one another.

The central region 104 and the peripheral region 106 of the antenna 100 are configured such that an optical gain pattern of the central region 104 and an RF gain pattern of the peripheral region 106 are co-boresighted. As used herein, “co-boresighted” refers to an axis of maximum gain of the central region 104 or optical zone being substantially aligned with an axis of maximum gain of the peripheral region 106 or RF zone. To achieve the co-boresighting of the optical zone and the RF zone, the two regions may share the same effective center relative to one another. The central region 104 and the peripheral region 106 may be formed in and/or on the substrate 100 using nano- and/or micro-patterning techniques. For example, the antenna 100 and other components described herein may be manufactured using known techniques, such as 3D printing, microelectromechanical systems (MEMS) manufacturing methods, additive manufacturing, photolithography, wafer processing techniques, etc. Preferably, the substrate 103 may be less than one millimeter in thickness.

FIG. 1B is a side view of the antenna 100 shown in FIG. 1A showing the receiving and focusing of optical signals with the antenna 100. The solid lines 108a-108e represent optical signals that are received at and enter a first side 110 of the antenna 100 and are focused at a distance, f, away from the substrate 103 on the second side 112 of the antenna 100. The spiral pattern 102 may focus the optical signals along a perpendicular axis 114 of the antenna 100 at the center of the central region 104 while also being capable of coupling RF signals into the antenna 100.

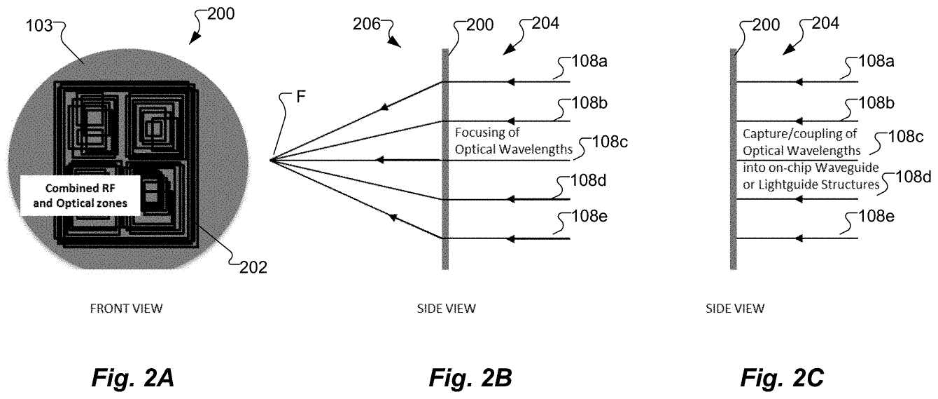

FIG. 2A is a front view of an antenna 200 having one or more non-spiral grating structures 202 configured to transmit and receive an optical signal and to transmit and receive an RF signal according to embodiments of the present invention. Similar to FIG. 1A, the grating structures 202 are formed on and/or in a substrate 103, e.g., a silicon or SIO wafer, and may include a metallic material. The grating structures 202 may include an array of optical gratings such that each grating optically couples free space (above the substrate) to one or more waveguides formed on and/or in the substrate, such as described in U.S. Pat. Publ. No. 2018/0175961 and U.S. Pat. Publ. No. 2018/0356597, which are incorporated by reference herein in their entirety.

FIG. 2B is a side view of the antenna 200 shown in FIG. 2A showing the receiving and focusing of optical signals with the antenna 200. The optical signals 108a-108e are received at and enter a first side 204 of the antenna 200 and are focused coherently at a point F on a second side 206.

FIG. 2C is a side view of an alternative configuration of the antenna 200 shown in FIG. 2A showing the receiving and capturing/coupling of optical signals with the antenna 200. The optical signals 108a-108e are received at and enter a first side 204 of the antenna 200 and are captured within the antenna 200 with one or more waveguides or light guide structures formed on and/or in the substrate 103.

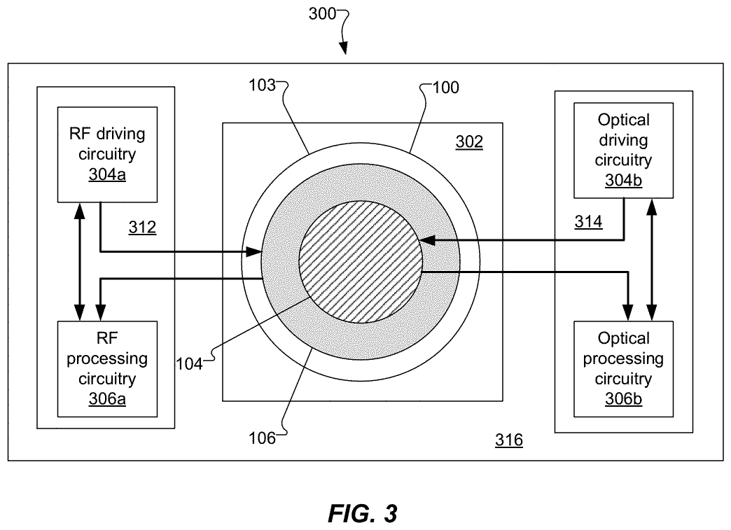

FIG. 3 shows an optical/RF antenna system 300 having an antenna, such as antenna 100 described above in FIGS. 1A and 1B, configured to transmit and receive optical and RF signals. The optical/RF antenna system 300 further includes driving circuitry 304a, 304b, in communication with the antenna 100, configured to drive the antenna so as to transmit the optical signals and/or RF signals. For example, optical driving circuitry 304b may be configured to drive the central region 104 so as to transmit the optical signal and RF driving circuitry 304a may be configured to drive the peripheral region 106 so as to transmit the RF signal. The optical driving circuitry 304b and/or the RF driving circuitry 304a may be formed on a surface of the substrate 103 (e.g., front and/or back surface) and/or in the substrate 103 or may be off the substrate 103 and coupled to the antenna 100.

The optical/RF antenna system 300 further includes processing circuitry 306a, 306b, in communication with the antenna 100, configured to process the optical signal and/or the RF signal received by the antenna 100. For example, optical processing circuitry 306b may be configured to process the optical signal received by the central region 104 and RF processing circuitry 306a may be configured to process the RF signal received by the peripheral region 106. The optical processing circuitry 306b and/or the RF processing circuitry 306a may be formed on a surface of the substrate 103 (e.g., front and/or back surface) and/or in the substrate 103 or may be off the substrate 103 and coupled to the antenna 100. The output of the processing circuitry 306a, 306b may vary depending on the particular application for which the optical/RF antenna system 300 is used. The RF driving circuitry 304a may be in communication with the RF processing circuitry 304b and may be part of a single component 312. Similarly, the optical driving circuitry 304b may be in communication with the optical processing circuitry 306b and may be part of a single component 314. The RF driving circuitry 304a, the RF processing circuitry 306a, the optical driving circuitry 304b, and the optical processing circuitry 306b may be part of a single component 316. The substrate 103, the RF driving circuitry 304a, the RF processing circuitry 306a, the optical driving circuitry 304b, and/or the optical processing circuitry 306b may be supported by a mechanical structure 302, the configuration of which may vary depending on the installation location of the antenna system 300.

Although the RF driving circuitry 304a, the RF processing circuitry 306a, the optical driving circuitry 304b, and the optical processing circuitry 306b are shown as separate components in FIG. 3, embodiments may combine one or more components for some applications. For example, the central region 104 and the peripheral region 106 may be driven by the same driving circuitry. Similarly, the same processing circuitry may process the optical signals from the central region 104 and the RF signals from the peripheral region 106. For example, certain circuitry may be combined based on the capability and availability of components to handle one or more frequency ranges. For instance, RF driving circuitry 304a may have an amplifier of a particular frequency range that may be outside the frequency range of the driving current or voltage necessary to drive the optical zone. Although FIG. 3 shows and describes the optical/RF antenna system 300 with an antenna 100 having a spiral grating structure, such as described in FIGS. 1A and 1B, embodiments of the optical/RF antenna system 300 may include an antenna 200 having non-spiral grating structures, such as described in FIGS. 2A-2C.

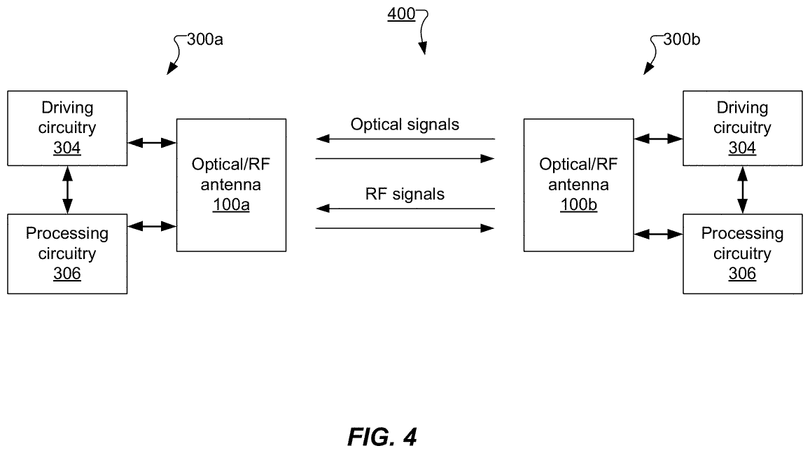

FIG. 4 shows a communication system 400 with a first optical/RF antenna system 300a in communication with a second optical/RF antenna system 300b. The first optical/RF antenna system 300a includes an antenna 100a coupled to driving circuitry 304 and processing circuitry 306, and the second optical/RF antenna system 300b includes an antenna 100b coupled to driving circuitry 304 and processing circuitry 306. The first optical/RF antenna system 300a may have the same components as the second antenna system 300b or the first and second optical/RF antenna systems 300a, 300b may have different components depending on the application. For example, the first optical/RF antenna system 300a may have fewer components than the second optical/RF antenna system 300b and only have the optical processing circuitry without the optical driving circuitry so that the first optical/RF antenna system 300a is only able to capture or focus received optical signals without being able to transmit optical signals.

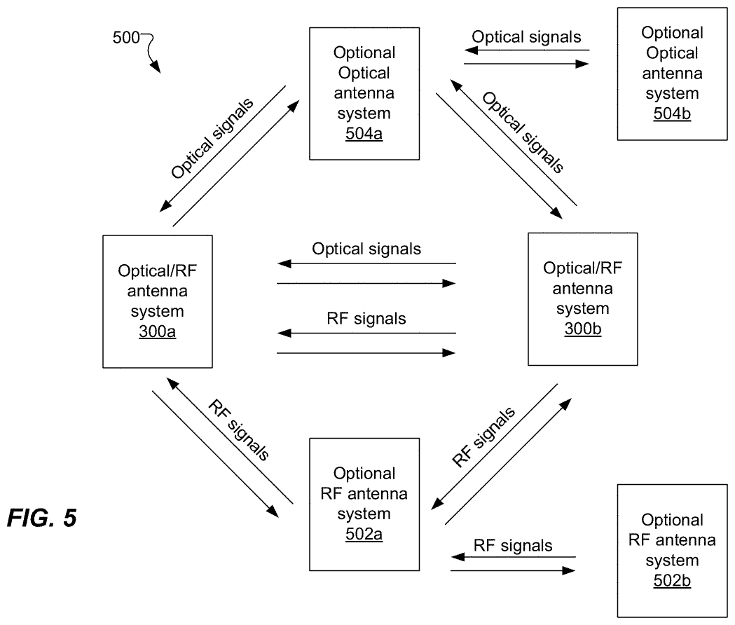

The optical/RF antenna systems 300 described herein may be configured to fit within existing communication networks. For example, FIG. 5 shows a communication network 500 with a first optical/RF antenna system 300a in communication with a second optical/RF antenna system 300b. In addition, the communication network 500 may include one or more RF antenna systems 502a, 502b, in communication with one another and with one or more of the optical/RF antenna systems 300a, 300b. The communication network 500 may also include one or more optical antenna systems 504a, 504b, in communication with one another and with one or more of the optical/RF antenna systems 300a, 300b.

Although the above discussion discloses various exemplary embodiments of the invention, it should be apparent that those skilled in the art may make various modifications that will achieve some of the advantages of the embodiments without departing from the true scope of the invention.

What is claimed is:

1. An optical and radio frequency (RF) antenna comprising:
a substrate; and
a spiral pattern formed on and/or in the substrate from a metallic material, the spiral pattern having a central region and a peripheral region surrounding the central region, the central region configured to transmit and receive an optical signal at optical and/or infrared wavelengths and the peripheral region configured to transmit and receive an RF signal at RF wavelengths, the central region and the peripheral region are configured such that an optical gain pattern of the central region and an RF gain pattern of the peripheral region are co-boresighted.

2. The optical and RF antenna according to claim 1, wherein the central region is configured to focus the optical signal at a distance away from the substrate.

3. The optical and RF antenna according to claim 1, wherein the spiral pattern is formed from two or more spiral patterns interleaved with one another.

4. The optical and RF antenna according to claim 1, wherein the spiral pattern is formed from two or more spiral patterns layered on top of one another.

5. The optical and RF antenna according to claim 1, wherein the spiral pattern is formed with a structured spiral having nanometer dimensions in the central region and micrometer dimensions in the peripheral region.

6. The optical and RF antenna according to claim 1, wherein the substrate is a silicon wafer.

7. An optical and RF antenna system comprising:
the optical and RF antenna according to claim 1;
first driving circuitry, in communication with the optical and RF antenna, configured to drive the central region so as to transmit the optical signal and/or configured to drive the peripheral region so as to transmit the RF signal; and
first processing circuitry, in communication with the optical and RF antenna, configured to process the optical signal received in the central region and/or configured to process the RF signal received in the peripheral region.

8. The optical and RF antenna system according to claim 7, wherein the first driving circuitry is formed on and/or in the substrate.

9. The optical and RF antenna system according to claim 7, wherein the first driving circuitry is coupled to the substrate.

10. The optical and RF antenna system according to claim 7, wherein the first processing circuitry is formed on and/or in the substrate.

11. The optical and RF antenna system according to claim 7, wherein the first processing circuitry is coupled to the substrate.

12. The optical and RF antenna system according to claim 7, further comprising:
second processing circuitry, in communication with the optical and RF antenna, configured to process the optical signal received in the central region and/or configured to process the RF signal received in the peripheral region.

13. The optical and RF antenna system according to claim 12, wherein the first processing circuitry is configured to process the optical signal received in the central region and the second processing circuitry is configured to process the RF signal received in the peripheral region.

14. The optical and RF antenna system according to claim 7, further comprising:
second driving circuitry, in communication with the optical and RF antenna, configured to drive the central region so as to transmit the optical signal and/or configured to drive the peripheral region so as to transmit the RF signal.

15. The optical and RF antenna system according to claim 14, wherein the first driving circuitry is configured to drive the central region and the second driving circuitry is configured to drive the peripheral region.

16. An optical and RF communication system comprising:
a first optical and RF antenna system according to claim 7; and
a second optical and RF antenna system according to claim 7 in communication with the first optical and RF antenna system.

17. The optical and RF communication system according to claim 16, further comprising:
one or more optical antenna systems in communication with the first optical and RF antenna system and/or the second optical and RF antenna system.

18. The optical and RF communication system according to claim 16, further comprising:
one or more RF antenna systems in communication with the first optical and RF antenna system and/or the second optical and RF antenna system.

19. The optical and RF communication system according to claim 16, further comprising:
one or more optical antenna systems in communication with the first optical and RF antenna system and/or the second optical and RF antenna system; and
one or more RF antenna systems in communication with the first optical and RF antenna system and/or the second optical and RF antenna system.

20. An optical and radio frequency (RF) antenna comprising:
a substrate; and
one or more optical-RF grating structures formed on and/or in the substrate from a metallic material, the one or more optical-RF grating structures configured to receive and transmit an optical signal at optical and/or infrared wavelengths and configured to receive and transmit an RF signal at RF wavelengths, the one or more optical-RF grating structures configured to focus the optical signal coherently, to transmit the optical signal coherently, to capture the optical signal into the substrate, to collect the RF signal into the substrate, and to transmit the RF signal.
